(19) United States
(12) Patent Application Publication
(10) Pub. No.: US 2022/0351514 A1
(43) Pub. Date: Nov. 3, 2022

(54) Image Recognition Method and Related Device

(71) Applicant: Huawei Technologies Co., Ltd., Shenzhen (CN)

(72) Inventor: Tao Lv, Shenzhen (CN)

(21) Appl. No.: 17/863,780

(22) Filed: Jul. 13, 2022

Related U.S. Application Data
(63) Continuation of application No. PCT/CN2020/071892, filed on Jan. 14, 2020.

(51) Int. Cl. G06V 20/00; G06V 10/25; G06V 10/771

(52) U.S. Cl. CPC G06V 20/36; G06V 10/25; G06V 10/771; G06V 2201/07

(57) ABSTRACT

In an image recognition method, a terminal determines, based on first positioning information, target object information corresponding to building information in a to-be-recognized image in desensitized map data. The desensitized map data does not include a sensitive building. Then, when the terminal determines that the target object information does not include the building information, the terminal determines that the map data does not include the building information. In this case, the terminal determines to recognize the building information as a sensitive building. In other words, the terminal may recognize, by using the desensitized map data, building information corresponding to a sensitive building in the to-be-recognized image.

### CROSS-REFERENCE TO RELATED APPLICATIONS

This is a continuation of International Patent Application No. PCT/CN2020/071892 filed on Jan. 14, 2020, which is hereby incorporated by reference in its entirety.

### TECHNICAL FIELD

This disclosure relates to the image information processing field, and in particular, to an image recognition method and a related device.

### BACKGROUND

A high definition map has higher precision data than a conventional two-dimensional map, and is used to assist in an automatic vehicle driving scenario. Generally, the high definition map is constructed based on a large amount of original image information such as pictures and videos. When the high definition map is constructed, sensitive building information such as a military forbidden area, a military facility, a national security department, and an undisclosed port and airport in the original image information needs to be desensitized.

In the conventional technology, a method for desensitizing original image information is mainly implemented through manual recognition. To be specific, sensitive building information included in building information in the original image information is marked through manual recognition, and then a sensitive building in the original image information is further erased, to implement desensitization on the original image information.

However, efficiency of the method for desensitizing original image information through manual recognition is relatively low. When a to-be-constructed high definition map is relatively large, a large amount of original image information exists inevitably, and a large amount of time needs to be consumed to implement desensitization on the original image information, resulting in relatively low efficiency.

### SUMMARY

Embodiments of this disclosure provide an image recognition method and a related device, to improve sensitive building recognition efficiency and reduce labor and time costs.

A first aspect of embodiments of this disclosure provides an image recognition method. The method may be applied to the image information processing field to implement sensitive building recognition. In the method, a terminal obtains a to-be-recognized image. The to-be-recognized image includes building information and first positioning information of the building information. Then the terminal may determine, based on the first positioning information, target object information corresponding to the building information in desensitized map data. The map data includes object information of each object on a map and second positioning information corresponding to the object information. Subsequently, the terminal determines whether the target object information includes the building information. If the target object information does not include the building information, the terminal determines that the building information is a sensitive building. The desensitized map data includes the object information of each object on the map and the positioning information corresponding to the object information on the map, and the map data does not include a sensitive building. When the terminal determines that the target object information does not include the building information, the terminal may determine that the map data does not include the building information and has recognized the building information as a sensitive building. In this case, the terminal determines to recognize the building information as a sensitive building. In other words, the terminal may recognize, by using the desensitized map data, building information corresponding to a sensitive building in the to-be-recognized image. Compared with an existing manual recognition technology, this can improve sensitive building recognition efficiency and reduce labor and time costs to some extent.

In a possible implementation of the first aspect of embodiments of this disclosure, the terminal determines, based on the first positioning information, target object information corresponding to the building information in desensitized map data. The terminal obtains the map data. The map data includes the object information and the second positioning information of the object information. Then the terminal determines the target object information in the map data based on the first positioning information and the second positioning information.

In this embodiment, the terminal may obtain the desensitized map data, for example, from another device through wired/wireless communication. Then the terminal may determine the second positioning information corresponding to the first positioning information in the map data, and determine that the object information corresponding to the second positioning information is the target object information corresponding to the building information. In this way, the terminal can directly determine the target object information.

In a possible implementation of the first aspect of embodiments of this disclosure, the terminal determines, based on the first positioning information, target object information corresponding to the building information in desensitized map data. The terminal sends a data request message to a map data server. The data request message includes the first positioning information. Then the terminal receives the target object information sent by the map data server.

In this embodiment, the terminal may determine the target object information through communication interaction with the map data server. Further, the terminal sends the data request message including the first positioning information to the map data server. In this case, the map data server may determine the second positioning information corresponding to the first positioning information in the map data, and determine that the object information corresponding to the second positioning information is the target object information corresponding to the building information. Then the map data server sends the target object information to the terminal, so that the terminal can determine the target object information. In this way, the terminal can determine the target object information without maintaining the map data in local.

In a possible implementation of the first aspect of embodiments of this disclosure, after the terminal determines that the building information is a sensitive building, the method further includes that the terminal deletes the building information from the to-be-recognized image to obtain a processed to-be-recognized image.

In this embodiment, after the terminal determines that the building information is a sensitive building, the terminal may delete the building information from the to-be-recognized image to obtain the processed to-be-recognized image. Subsequently, the sensitive building can be avoided on a map that is constructed by using the processed to-be-recognized image.

In a possible implementation of the first aspect of embodiments of this disclosure, the method further includes the following. In response to a review instruction of a user for the building information, the terminal triggers deletion of the building information from the to-be-recognized image to obtain the processed to-be-recognized image.

In this embodiment, before the terminal deletes the building information from the to-be-recognized image, a manual review process may be further performed. To be specific, only when the terminal generates a review instruction through manual review performed by the user and the review instruction determines that the building information is a sensitive building, the terminal triggers the deletion of the building information from the to-be-recognized image. This further improves the solution, and can avoid inadvertent deletion of information from the to-be-recognized image.

In a possible implementation of the first aspect of embodiments of this disclosure, when the terminal determines that the target object information includes the building information, the terminal determines that the building information is not a sensitive building.

In this embodiment, when the terminal determines that the target object information includes the building information, the desensitized map data includes each piece of object information on the map and the positioning information corresponding to the object information on the map, and the map data does not include a sensitive building. When the terminal determines that the target object information includes the building information, the terminal may determine that the map data includes the building information. In this case, the terminal may determine to recognize the building information as an insensitive building. This implements insensitive building recognition on the to-be-recognized image.

In a possible implementation of the first aspect of embodiments of this disclosure, the map data includes point of interest (POI) data.

In this embodiment, the map data may be implemented by using the POI data. Generally, the POI data includes at least four types of information: “name”, “class”, “coordinates”, and “category”. This provides a specific implementation of the map data in an implementation process. In the implementation process of the solution, in addition to the POI data, the map data may alternatively be implemented in another form such as two-dimensional map data or three-dimensional map data. This is not limited herein.

In a possible implementation of the first aspect of embodiments of this disclosure, a terminal obtains a to-be-recognized image. The terminal receives an original image sent by an image collection device. When the original image includes the building information, the terminal determines the original image as the to-be-recognized image.

In this embodiment, the method may be applied to a high definition map construction process. The terminal may directly serve as an image collection device to implement sensitive building recognition, or may serve as a background terminal that interacts with an image collection device to implement sensitive building recognition. When the terminal serves as the background terminal that interacts with the image collection device, the terminal receives the original image sent by the image collection device. Therefore, when the original image includes the building information, the terminal may determine that the original image is the to-be-recognized image, and implement image recognition on the to-be-recognized image by using the foregoing method.

A second aspect of embodiments of this disclosure provides a terminal. The terminal has functions of implementing the method according to the first aspect or any possible implementation of the first aspect. The functions may be implemented by hardware, or may be implemented by hardware executing corresponding software. The hardware or software includes one or more modules corresponding to the functions, for example, an obtaining unit, a determining unit, a judging unit, and a processing unit.

A third aspect of embodiments of this disclosure provides a terminal. The terminal includes at least one processor, a memory, a communications port, and computer-executable instructions that are stored in the memory and that can be run on the processor. When the computer-executable instructions are executed by the processor, the processor performs the method according to the first aspect or any possible implementation of the first aspect.

A fourth aspect of embodiments of this disclosure provides a computer-readable storage medium storing one or more computer-executable instructions. When the computer-executable instructions are executed by a processor, the processor performs the method according to the first aspect or any possible implementation of the first aspect.

A fifth aspect of embodiments of this disclosure provides a computer program product storing one or more computer-executable instructions. When the computer-executable instructions are executed by a processor, the processor performs the method according to the first aspect or any possible implementation of the first aspect.

A sixth aspect of embodiments of this disclosure provides a chip system. The chip system includes a processor configured to support a controller in implementing the functions according to the first aspect or any possible implementation of the first aspect. In a possible design, the chip system may further include a memory. The memory is configured to store program instructions and data. The chip system may include a chip, or may include a chip and another discrete component.

For technical effects brought by any one of the second aspect to the sixth aspect or the possible implementations of the second aspect to the sixth aspect, refer to the technical effects brought by the first aspect or the different possible implementations of the first aspect. Details are not described herein again.

In the technical solutions provided in embodiments of this disclosure, a terminal obtains a to-be-recognized image. The to-be-recognized image includes building information and first positioning information of the building information. The terminal determines, based on the first positioning information, target object information corresponding to the building information in desensitized map data. The terminal determines whether the target object information includes the building information. If no, the terminal determines that the building information is a sensitive building. The desensitized map data includes each piece of object information on a map and positioning information corresponding to the object information on the map, and the map data does not include a sensitive building. When the terminal determines that the target object information does not include the building information, the terminal may determine that the map data does not include the building information and has recognized the building information as a sensitive building. In this case, the terminal determines to recognize the building information as a sensitive building. In other words, the terminal may recognize, by using the desensitized map data, building information corresponding to a sensitive building in the to-be-recognized image. Compared with an existing manual recognition technology, this can improve sensitive building recognition efficiency and reduce labor and time costs to some extent.

### BRIEF DESCRIPTION OF DRAWINGS

FIG. 1 is a schematic diagram of a system of an image recognition method according to an embodiment;

FIG. 2 is a schematic flowchart of an image recognition method according to an embodiment;

FIG. 3 is another schematic flowchart of an image recognition method according to an embodiment;

FIG. 4 is a schematic diagram of another system of an image recognition method according to an embodiment;

FIG. 5 is another schematic flowchart of an image recognition method according to an embodiment;

FIG. 6 is a schematic diagram of a terminal according to an embodiment; and

FIG. 7 is another schematic diagram of a terminal according to an embodiment.

### DESCRIPTION OF EMBODIMENTS

The following clearly describes the technical solutions in embodiments of this disclosure with reference to the accompanying drawings in embodiments.

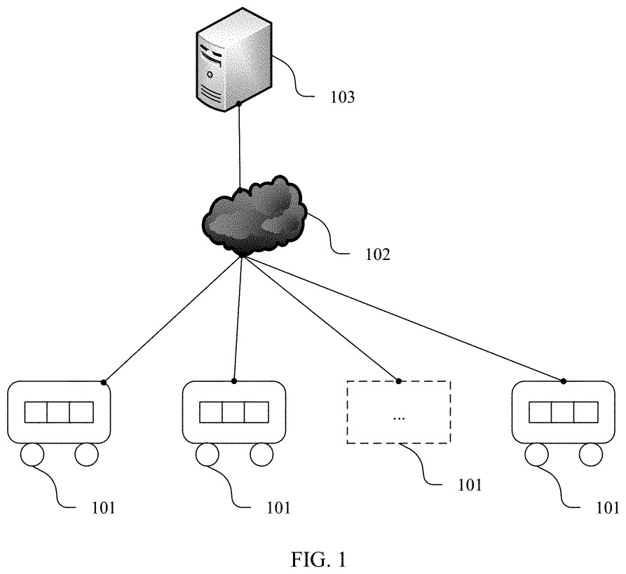

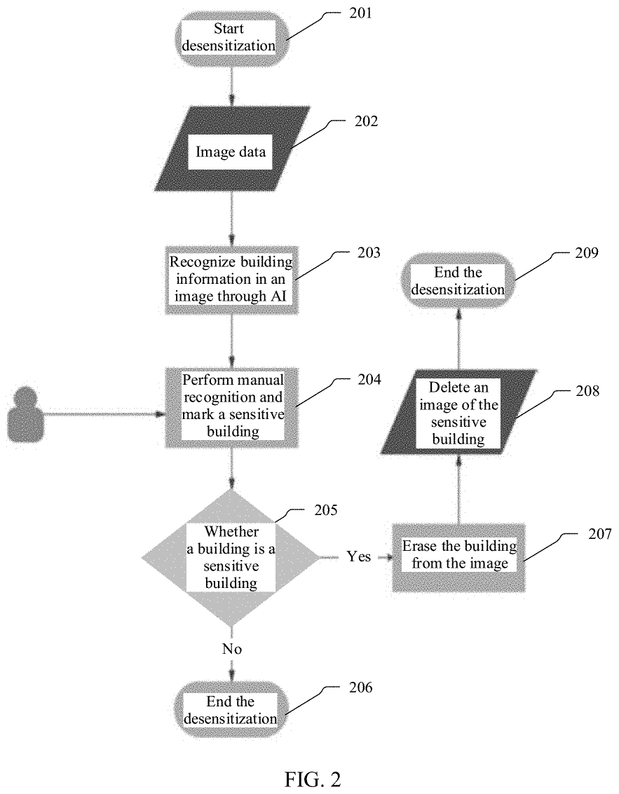

Refer to FIG. 1. A high definition map construction process generally needs an image collection process. For example, an image may be obtained by using an image collection device, or may be obtained through crowdsourcing or in another form. For example, as shown in FIG. 1, one or more image collection devices perform onsite image collection. An example in which the image collection device is a collection vehicle 101 is used for description in FIG. 1. It may be understood that, in addition to the collection vehicle 101, the image collection device may alternatively be another image collection device such as a vehicle-mounted terminal or a mobile phone. The collection vehicle 101 obtains original data (including an image, a video, and the like) through photographing. Generally, the original data may mainly include location data, point cloud data, image and video data, and vehicle body information. Then the collection vehicle 101 further uploads the data to a cloud 102, and an image processing terminal 103 may share the original data by using the cloud 102 and further construct a high definition map. During the construction, according to related national regulations, the image processing terminal 103 needs to desensitize sensitive building information such as a military forbidden area, a military facility, a national security department, and an undisclosed port and airport in original image information, as shown in FIG. 2.

Step 201: Start desensitization.

Step 202: Obtain image data.

Step 203: Recognize building information in an image through artificial intelligence (M).

Step 204: A user participates to perform manual recognition and mark a sensitive building.

Step 205: Determine whether a building is a sensitive building; and if yes, perform step 207; or if no, perform step 206.

Step 206: End the desensitization.

Step 207: Erase the building from the image.

Step 208: Delete an image of the sensitive building.

Step 209: End the desensitization.

As shown in FIG. 2, the data desensitization process may be performed through AI recognition or manual recognition. The AI recognition is to recognize building information in a picture, then manually mark whether the building information is sensitive building information, and finally erase a sensitive building in the picture. However, in the method, efficiency of the method for desensitizing original image information through manual recognition is relatively low. When a to-be-constructed high definition map is relatively large, a large amount of original image information exists inevitably, and a large amount of time needs to be consumed to implement desensitization on the original image information, resulting in relatively low efficiency. Therefore, embodiments of this disclosure provide an image recognition method and a related device, to improve sensitive building recognition efficiency and reduce labor and time costs.

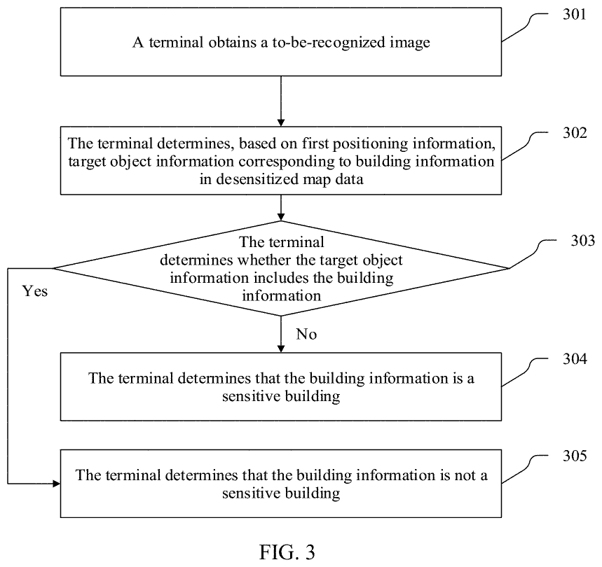

Refer to FIG. 3. An embodiment of an image recognition method according to an embodiment of this disclosure includes the following steps.

301: A terminal obtains a to-be-recognized image.

In this embodiment, the terminal obtains the to-be-recognized image. The to-be-recognized image includes building information and first positioning information of the building information.

Further, the terminal may be applied to the image information processing field to implement sensitive building recognition. A specific implementation may be a mobile phone, a computer, a server, or another terminal device. This is not limited herein. For example, the method may be applied to a high definition map construction process. The terminal may directly serve as an image collection device to implement sensitive building recognition, or may serve as a background terminal that interacts with an image collection device to implement sensitive building recognition. When the terminal directly serves as the image collection device, the terminal performs building photographing by using a camera device carried by the terminal or an external camera device, to obtain the to-be-recognized image. When the terminal serves as the background terminal that interacts with the image collection device, the terminal receives an original image sent by the image collection device. Therefore, when the original image includes the building information, the terminal may determine that the original image is the to-be-recognized image, and implement image recognition on the to-be-recognized image by using the foregoing method.

In addition, in this embodiment, the terminal may determine the building information in the to-be-recognized image through AI learning, or determine the building information in the to-be-recognized image by determining other image feature information. This is not limited herein.

302: The terminal determines, based on the first positioning information, target object information corresponding to the building information in desensitized map data.

In this embodiment, the terminal determines, based on the first positioning information, the target object information corresponding to the building information in the desensitized map data. The map data includes object information and second positioning information of the object information.

There are a plurality of methods in which the terminal determines the target object information, and the following separately describes the methods.

1. The terminal determines the target object information by using map data maintained by the terminal.

That the terminal determines, based on the first positioning information, target object information corresponding to the building information in desensitized map data includes that the terminal obtains the map data. The map data includes the object information and the second positioning information of the object information. Then the terminal determines the target object information in the map data based on the first positioning information and the second positioning information. In this embodiment, the terminal may obtain the desensitized map data, for example, from another device through wired/wireless communication. Then the terminal may determine the second positioning information corresponding to the first positioning information in the map data, and determine that the object information corresponding to the second positioning information is the target object information corresponding to the building information. In this way, the terminal can directly determine the target object information in local.

2. The terminal determines the target object information by using a map data server.

That the terminal determines, based on the first positioning information, target object information corresponding to the building information in desensitized map data includes that the terminal sends a data request message to the map data server. The data request message includes the first positioning information. Then the terminal receives the target object information sent by the map data server. In this embodiment, the terminal may determine the target object information through communication interaction with the map data server. Further, the terminal sends the data request message including the first positioning information to the map data server. In this case, the map data server may determine the second positioning information corresponding to the first positioning information in the map data, and determine that the object information corresponding to the second positioning information is the target object information corresponding to the building information. Then the map data server sends the target object information to the terminal, so that the terminal can determine the target object information. In this way, the terminal can determine the target object information without maintaining the map data in local.

303: The terminal determines whether the target object information includes the building information.

In this embodiment, the terminal further determines, by using the target object information obtained in step 302, whether the target object information includes the building information; and if yes, performs step 305; or if no, performs step 304.

In this embodiment, the map data may be implemented by using POI data. Generally, the POI data includes at least four types of information: “name”, “class”, “coordinates”, and “category”. This provides a specific implementation of the map data in an implementation process. In the implementation process of the solution, in addition to the POI data, the map data may alternatively be implemented in another form such as two-dimensional map data or three-dimensional map data. This is not limited herein. In this embodiment, only an example in which the map data includes the POI data is used for description.

In a determining process in step 303, if the terminal has marked the target object information as a sensitive building in the map data based on a feature of the POI data, the map data may set the target object information to be empty or replace the target object information with other information. Therefore, the determining process in which the terminal determines whether the target object information includes the building information may include that the terminal determines whether the target object information is empty POI data, or learn, through parsing, whether POI data of the target object information includes the building information in the to-be-recognized image in step 301.

304: If no, the terminal determines that the building information is a sensitive building.

In this embodiment, the desensitized map data includes object information of each object on a map and positioning information corresponding to the object information on the map, and the map data does not include a sensitive building. When the terminal determines that the target object information does not include the building information in step 303, the terminal may determine that the map data does not include the building information and has recognized the building information as a sensitive building. In this case, the terminal determines to recognize the building information as a sensitive building. In other words, the terminal may recognize, by using the desensitized map data, building information corresponding to a sensitive building in the to-be-recognized image. Compared with an existing manual recognition technology, this can improve sensitive building recognition efficiency and reduce labor and time costs to some extent.

In an implementation, after the terminal determines that the building information is a sensitive building in step 304, the method further includes that the terminal deletes the building information from the to-be-recognized image to obtain a processed to-be-recognized image. In this embodiment, after the terminal determines that the building information is a sensitive building, the terminal may delete the building information from the to-be-recognized image to obtain the processed to-be-recognized image. Subsequently, the sensitive building can be avoided on a map that is constructed by using the processed to-be-recognized image.

In addition, before the terminal deletes the building information from the to-be-recognized image, a manual review process may be further performed. To be specific, only when the terminal generates a review instruction through manual review performed by a user and the review instruction determines that the building information is a sensitive building, the terminal triggers the deletion of the building information from the to-be-recognized image. This further improves the solution, and can avoid inadvertent deletion of information from the to-be-recognized image.

305: If yes, the terminal determines that the building information is not a sensitive building.

In this embodiment, when the terminal determines that the target object information includes the building information, the method further includes that the terminal determines that the building information is not a sensitive building.

In this embodiment, the desensitized map data includes each piece of object information on the map and the positioning information corresponding to the object information on the map, and the map data does not include a sensitive building. When the terminal determines that the target object information includes the building information in step 303, the terminal may determine that the map data includes the building information. In this case, the terminal may determine to recognize the building information as an insensitive building. This implements insensitive building recognition on the to-be-recognized image.

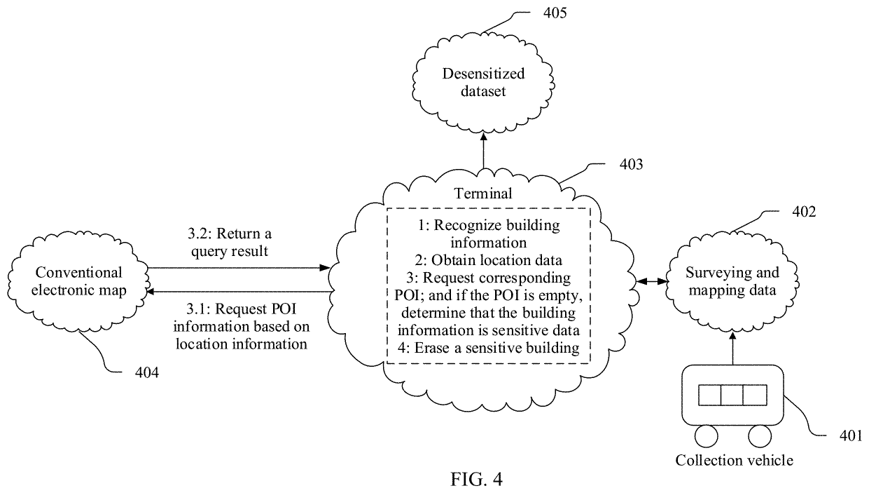

For a specific implementation process, refer to content of a system framework in FIG. 4. A collection vehicle 401 obtains surveying and mapping data, and uploads the data to a surveying and mapping data server 402. A terminal 403 performs a related image recognition process in this embodiment. The specific process is as follows.

Step 1: Recognize building information.

Step 2: Obtain location data.

Step 3: Request corresponding POI; and if the POI is empty, determine that the building information is sensitive data.

Step 4: Erase a sensitive building, and then upload a desensitized dataset to a cloud or a corresponding server 405 for storage.

A process of performing step 3 may include the following steps.

Step 3.1: The terminal 403 requests POI information from a conventional electronic map server 404 based on location information.

Step 3.2: The conventional electronic map server 404 returns a query result to the terminal 403.

A difference from the foregoing image recognition implementation is that, in a process of erasing sensitive building information, POI information for invoking a conventional electronic map is added, and whether building information is sensitive building information is determined based on whether POI is empty. To implement quick sensitive building recognition, a desensitization process is as follows. After collecting the surveying and mapping data, the collection vehicle uploads the data to the terminal for processing. The surveying and mapping data include a picture that needs to be desensitized and currently collected location data. The terminal recognizes building information in the picture through AI, calculates an actual location of a building in the picture based on the collected location information and picture information, obtains POI information of a corresponding location on a conventional map, and if obtained POI is empty, determines that the building is marked as a sensitive building on the conventional map. In this case, a system marks the building in the picture as a sensitive building.

An interface parameter for invoking the conventional map herein includes at least information in Table 1:

TABLE 1

| Parameter | Description |
|---|---|
| Request parameter: | Actual location information of a building, used to |
| location | obtain a POI value of a corresponding location |
| Return value: POI | Return a POI value at a specified location |

An invoked interface is an interface provided by the conventional electronic map. After manual review, the terminal may erase a sensitive building from a picture, and then may upload a desensitized image dataset to a corresponding server for storage and maintenance.

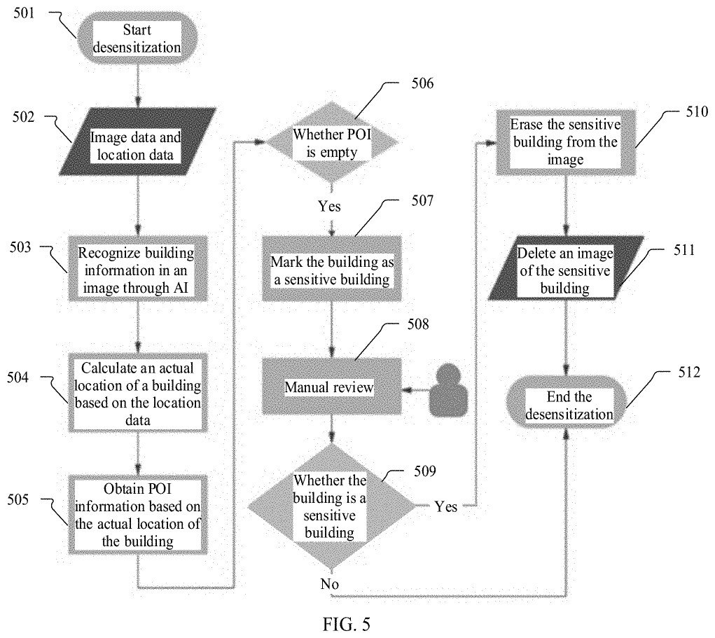

Refer to FIG. 5. Another image recognition method according to an embodiment of this disclosure includes the following steps.

Step 501: Start desensitization.

Step 502: Obtain image data and location data.

Step 503: Recognize building information in an image through AI.

Step 504: Calculate an actual location of a building based on the location data.

Step 505: Obtain POI information based on the actual location of the building.

Step 506: Determine whether POI is empty; and if yes, perform step 507.

Step 507: Mark the building as a sensitive building.

Step 508: A user performs manual review.

Step 509: Determine whether the building is a sensitive building; and if yes, perform step 510; or if no, perform step 512.

Step 510: Erase the sensitive building from the image.

Step 511: Delete an image of the sensitive building.

Step 512: End the desensitization.

During the method implementation performed by the terminal, the terminal obtains collected image or video data and corresponding location information, recognizes building information in an image through AI, obtains a building location based on an uploaded location, searches conventional map data for corresponding POI information based on building location information, if the POI information does not exist, marks the building as a sensitive building, and if the building is determined as a sensitive building after manual review, further erases the building from the image or video. This can effectively reduce manual marking costs, and can improve efficiency of erasing sensitive building information from a picture.

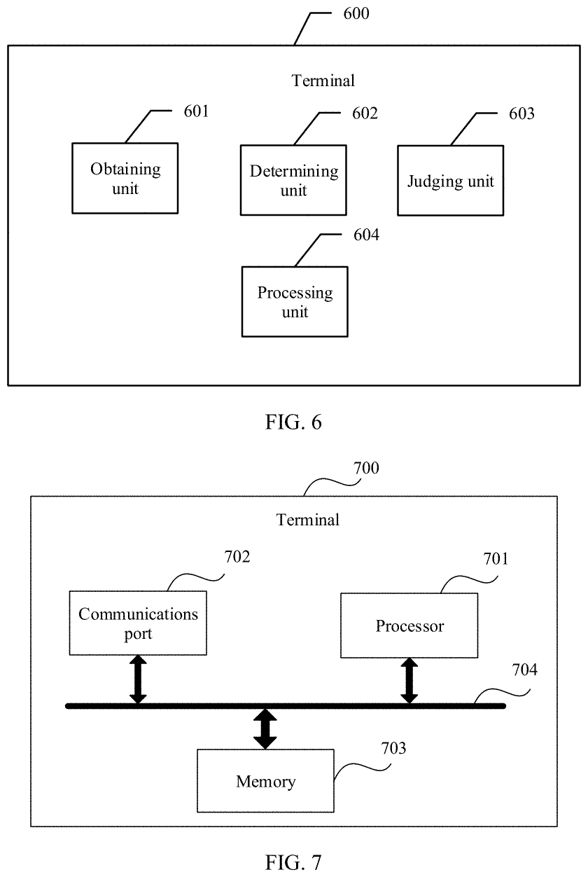

Refer to FIG. 6. A terminal 600 according to an embodiment of this disclosure includes an obtaining unit 601 configured to obtain a to-be-recognized image, where the to-be-recognized image includes building information and first positioning information of the building information, a determining unit 602 configured to determine, based on the first positioning information, target object information corresponding to the building information in desensitized map data, where the map data includes object information and second positioning information of the object information, and a judging unit 603 configured to determine whether the target object information includes the building information.

The determining unit 602 is further configured to, when the judging unit determines that the target object information does not include the building information, determine that the building information is a sensitive building.

In an implementation, the determining unit 602 is further configured to obtain the map data, and determine the target object information in the map data based on the first positioning information and the second positioning information.

In an implementation, the determining unit 602 is further configured to send a data request message to a map data server, where the data request message includes the first positioning information, and receive the target object information sent by the map data server.

In an implementation, the terminal 600 further includes a processing unit 604 configured to delete the building information from the to-be-recognized image to obtain a processed to-be-recognized image.

In an implementation, the processing unit 604 is further configured to, in response to a review instruction of a user for the building information, trigger deletion of the building information from the to-be-recognized image to obtain the processed to-be-recognized image.

In an implementation, when the terminal determines that the target object information includes the building information, the determining unit 602 is further configured to determine that the building information is not a sensitive building.

In an implementation, the map data includes POI data.

In an implementation, the obtaining unit 601 is further configured to receive an original image sent by an image collection device, and when the original image includes the building information, determine the original image as the to-be-recognized image.

It should be noted that, for specific content such as information exchange and execution processes of the units of the terminal 600, refer to the descriptions in the foregoing method embodiments of this disclosure. Details are not described herein again.

FIG. 7 is a schematic diagram of a possible logical structure of a terminal 700 in the foregoing embodiment according to an embodiment of this disclosure. The terminal 700 includes a processor 701, a communications port 702, a memory 703, and a bus 704. The processor 701, the communications port 702, and the memory 703 are connected to each other through the bus 704. In this embodiment of this disclosure, the processor 701 is configured to control an action of the terminal 700. For example, the processor 701 is configured to perform the functions performed by the determining unit 602, the judging unit 603, and the processing unit 604 in FIG. 6. The communications port 702 is configured to perform the functions performed by the obtaining unit 601 in FIG. 6, and support the terminal 600 in performing communication. The memory 703 is configured to store program code and data of the terminal 600.

The processor 701 may be a central processing unit, a general-purpose processor, a digital signal processor, an application-specific integrated circuit, a field programmable gate array or another programmable logical device, a transistor logical device, a hardware component, or any combination thereof. The processor may implement or execute various example logical blocks, modules, and circuits described with reference to content disclosed in this disclosure. The processor may alternatively be a combination for implementing a computing function, for example, a combination including one or more microprocessors, or a combination of a digital signal processor and a microprocessor. The bus 704 may be a Peripheral Component Interconnect (PCI) bus, an Extended Industry Standard Architecture (EISA) bus, or the like. The bus may be classified into an address bus, a data bus, a control bus, and the like. For ease of representation, only one bold line is used for representation in FIG. 7, but this does not mean that there is only one bus or only one type of bus.

An embodiment of this disclosure further provides a computer-readable storage medium storing one or more computer-executable instructions. When the computer-executable instructions are executed by a processor, the processor performs the power switching control method.

An embodiment of this disclosure further provides a computer program product storing one or more computer-executable instructions. When the computer-executable instructions are executed by a processor, the processor performs the power switching control method.

This disclosure further provides a chip system. The chip system includes a processor configured to support a terminal in implementing the functions in the power switching control method. In a possible design, the chip system may further include a memory. The memory is configured to store program instructions and data. The chip system may include a chip, or may include a chip and another discrete component.

A person skilled in the art may clearly understand that, for convenient and brief description, for detailed working processes of the foregoing system, apparatus, and unit, refer to corresponding processes in the foregoing method embodiments. Details are not described herein again.

In several embodiments provided in this disclosure, it should be understood that the disclosed system, apparatus, and method may be implemented in another manner. For example, the described apparatus embodiment is merely an example. For example, unit division is merely logical function division, and may be other division during actual implementation. For example, a plurality of units or components may be combined or integrated into another system, or some features may be ignored or not performed. In addition, the displayed or discussed mutual couplings or direct couplings or communication connections may be implemented through some interfaces. The indirect couplings or communication connections between the apparatuses or units may be implemented in electronic, mechanical, or other forms.

The units described as separate parts may or may not be physically separate, and parts displayed as units may or may not be physical units, in other words, may be located in one position, or may be distributed on a plurality of network units. Some or all of the units may be selected according to actual requirements to achieve the objectives of the solutions of embodiments.

In addition, function units in embodiments of this disclosure may be integrated into one processing unit, or each of the units may exist alone physically, or two or more units are integrated into one unit. The integrated unit may be implemented in a form of hardware, or may be implemented in a form of a software function unit.

When the integrated unit is implemented in the form of a software service unit and sold or used as an independent product, the integrated unit may be stored in a computer-readable storage medium. Based on such an understanding, the technical solutions of this disclosure essentially, or the part contributing to the conventional technology, or all or some of the technical solutions may be implemented in a form of a software product. The computer software product is stored in a storage medium, and includes several instructions to enable a computer device (which may be a personal computer, a server, a network device, or the like) to perform all or some of the steps of the method described in embodiments of this disclosure. The storage medium includes any medium that can store program code, such as a Universal Serial Bus (USB) flash drive, a removable hard disk, a read-only memory (ROM), a random-access memory (RAM), a magnetic disk, or a compact disc.

What is claimed is:

1. A method implemented by a terminal, wherein the method comprises:
obtaining a to-be-recognized image comprising building information and first positioning information of the building information;
determining, based on the first positioning information, target object information corresponding to the building information in desensitized map data, wherein the desensitized map data comprises object information and second positioning information of the object information;
determining whether the target object information comprises the building information; and
determining that the building information is a sensitive building when the target object information does not comprise the building information.

2. The method of claim 1, further comprising:
obtaining the desensitized map data; and
further determining, based on the second positioning information and the desensitized map data, the target object information.

3. The method of claim 1, further comprising sending, to a map data server, a data request message comprising the first positioning information, wherein determining the target object information comprises receiving, from the map data server and in response to the data request message, the target object information.

4. The method of claim 1, wherein after determining that the building information is the sensitive building, the method further comprises deleting the building information from the to-be-recognized image to obtain a processed to-be-recognized image.

5. The method of claim 4, further comprising:
obtaining a review instruction of a user for the building information; and
triggering, in response to the review instruction, deletion of the building information from the to-be-recognized image to obtain the processed to-be-recognized image.

6. The method of claim 1, further comprising:
determining that the target object information comprises the building information; and
determining, in response to determining that the target object information comprises the building information, that the building information is not the sensitive building.

7. The method of claim 1, wherein the desensitized map data comprise point of interest (POI) data.

8. The method of claim 1, wherein obtaining the to-be-recognized image comprises:
receiving, from an image collection device, an original image;
identifying that the original image comprises the building information; and
setting, in response to the original image comprising the building information, the original image as the to-be-recognized image.

9. A terminal comprising:
a memory configured to store instructions; and
a processor coupled to the memory and configured to execute the instructions to cause the terminal to:
obtain a to-be-recognized image comprising building information and first positioning information of the building information;
determine, based on the first positioning information, target object information corresponding to the building information in desensitized map data, wherein the desensitized map data comprises object information and second positioning information of the object information;
determine whether the target object information comprises the building information; and
determine that the building information is a sensitive building when the target object information does not comprise the building information.

10. The terminal of claim 9, wherein the processor is further configured to execute the instructions to cause the terminal to:
obtain the desensitized map data; and
further determine, based on the second positioning information and the desensitized map data, the target object information.

11. The terminal of claim 9, wherein the processor is further configured to execute the instructions to cause the terminal to:
send, to a map data server, a data request message comprising the first positioning information; and
receive, from the map data server and in response to the data request message, the target object information.

12. The terminal of claim 9, wherein the processor is further configured to execute the instructions to cause the terminal to delete the building information from the to-be-recognized image to obtain a processed to-be-recognized image.

13. The terminal of claim 12, wherein the processor is further configured to execute the instructions to cause the terminal to:
obtain a review instruction of a user for the building information; and
trigger, in response to the review instruction, deletion of the building information from the to-be-recognized image to obtain the processed to-be-recognized image.

14. The terminal of claim 9, wherein the processor is further configured to execute the instructions to cause the terminal to:
determine that the target object information comprises the building information; and
determine, in response to determining that the target object information comp[rises the building information, that the building information is not the sensitive building.

15. The terminal of claim 9, wherein the desensitized map data comprises point of interest (POI) data.

16. The terminal of claim 9, wherein the processor is further configured to execute the instructions to cause the terminal to:
receive, from an image collection device, an original image;
identify that the original image comprises the building information; and
determine, in response to the original image comprising the building information, the original image as the to-be-recognized image.

17. A computer program product comprising computer-executable instructions stored on a non-transitory computer-readable medium that, when executed by a processor, cause a terminal to:
obtain a to-be-recognized image comprising building information and first positioning information of the building information;
determine, based on the first positioning information, target object information corresponding to the building information in desensitized map data, wherein the desensitized map data comprises object information and second positioning information of the object information;
determine whether the target object information comprises the building information; and
determine that the building information is a sensitive building when the target object information does not comprise the building information.

18. The computer program product of claim 17, wherein the computer-executable instructions further cause the terminal to:
obtain the desensitized map data; and
further determine, based on the second positioning information and the desensitized map data, the target object information.

19. The computer program product of claim 17, wherein the computer-executable instructions further cause the terminal apparatus to:
send, to a map data server, a data request message comprising the first positioning information; and
receive, from the map data server and in response to the data request message, the target object information.

20. The computer program product of claim 17, wherein the computer-executable instructions further cause the terminal to delete the building information from the to-be-recognized image to obtain a processed to-be-recognized image.
